(19) United States
(12) Patent Application Publication
(10) Pub. No.: US 2009/0195900 A1
(43) Pub. Date: Aug. 6, 2009

(54) METHOD AND APPARATUS FOR FABRICATING A GEL STRING

(76) Inventor: Jack Calmes, Dallas, TX (US)

Correspondence Address: DOCKET CLERK, P.O. DRAWER 800889, DALLAS, TX, 75380, US

(21) Appl. No.: 12/355,510

(22) Filed: Jan. 16, 2009

Related U.S. Application Data
(60) Provisional application No. 61/011,556, filed on Jan. 18, 2008.

(51) Int. Cl. G02B 5/22; B29C 65/08

(52) U.S. Cl. 359/890; 156/73.4; 156/73.2

(57) ABSTRACT

Systems and methods are disclosed that include overlapping a first portion of a first piece of flexible filter material and a second portion of a second piece of flexible filter material. In these systems and methods, the first and second pieces of flexible filter material produce a desired change in a characteristic of a light beam. These systems and methods can include clamping the first portion and the second portion between a first element and a second element. In addition, these systems and methods can include producing ultrasonic vibrations in the first element that promotes a bond between the first and second piece of flexible filter material.

### CROSS-REFERENCE TO RELATED APPLICATIONS

The present application is related to and claims priority to U.S. Provisional Patent Application Ser. No. 61/011,556, entitled “Method and Apparatus for Fabricating a Gel String,” filed on Jan. 18, 2008, which is assigned to the assignee of the present application. The subject matter disclosed in Provisional Patent Application Ser. No. 61/011,556 is hereby incorporated by reference into the present disclosure as if fully set forth herein. The present application hereby claims priority under 35 U.S.C. §119(e) to U.S. Provisional Patent Application Ser. No. 61/011,556.

### TECHNICAL FIELD

The present invention relates to automated lighting equipment, and in particular, to a method and apparatus of fabricating a gel string.

### BACKGROUND

Characteristics such as color and beam shape of a light beam emitted by a light fixture may be controlled with filter materials placed in the light beam. Where the light beam has a round cross section, a rectangular piece of filter material may be placed across the light beam. Because some color filter material was originally made of a gelatin-based substance, such color filters came to be commonly referred to as ‘gels.’ The term ‘gel’ is now also used to refer to flexible filter material that changes other characteristics of a light beam than color, such as diffusion and/or beam divergence.

Because gels and other filter materials are flexible, two or more such pieces may be fastened together at their edges to form a sequence of pieces of filter material. Such a sequence of pieces of filter material may be referred to as a ‘gel string.’ Each end of such a gel string may be wrapped around a cylinder and the cylinders positioned on opposite sides of the light fixture with the portion of the gel string between the cylinders positioned across the light beam. By providing the cylinders with motors and a controller, the gel string may be scrolled between the cylinders to position a desired portion of the gel scroll across the light beam. Such a mechanism may be referred to as a ‘gel scroller’ and enables desired characteristics of a light beam to be modified by positioning a desired piece of filter material in the beam.

### SUMMARY

In one embodiment, a methods is disclosed that includes overlapping a first portion of a first piece of flexible filter material and a second portion of a second piece of flexible filter material. In this method, the first and second pieces of flexible filter material produce a desired change in a characteristic of a light beam. This method also includes clamping the first portion and the second portion between a first element and a second element. In addition, this method can include producing ultrasonic vibrations in the first element that promotes a bond between the first and second piece of flexible filter material.

In another embodiment, a gel string prepared by a process is disclosed. This process includes providing a first portion of a first piece of flexible filter material, providing a second portion of a second piece of flexible filter material, and clamping the first portion and the second portion between a first element and a second element. In addition, this process further includes producing ultrasonic vibrations in the first element, whereby the first portion and the second portion are bonded.

In yet another embodiment, a system is disclosed that includes a first filter material that creates a first alteration of at least one characteristic of a light beam passing through the first filter material. This system also includes a second filter material that creates a second alteration of at least one characteristic of the light beam passing through the first filter material. In addition, this system includes a bond that includes at least part of the first filter material and at least part of the second filter material. This bond is created in situ through energy transferred to the first filter material and secures an overlap area of the first filter material and the second filter material.

The foregoing has outlined rather broadly the features and technical advantages of the present invention so that those skilled in the art may better understand the detailed description of the invention that follows. Additional features and advantages of the invention will be described hereinafter that form the subject of the claims of the invention. Those skilled in the art should appreciate that they may readily use the conception and the specific embodiment disclosed as a basis for modifying or designing other structures for carrying out the same purposes of the invention. Those skilled in the art should also realize that such equivalent constructions do not depart from the spirit and scope of the invention in its broadest form.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior uses, as well as to future uses, of such defined words and phrases.

### BRIEF DESCRIPTION OF THE DRAWINGS

For a more complete understanding of the present invention, and the advantages thereof, reference is now made to the following descriptions taken in conjunction with the accompanying drawings, wherein like numbers designate like objects, in which:

FIG. 1 shows a front view of an apparatus according to the present disclosure for fastening together pieces of filter material;

FIG. 2 depicts a top view of the apparatus OF FIG. 1;

FIG. 3 shows a gel string fabricated according to the present disclosure; and

FIG. 4 depicts an automated lighting fixture including a gel string of the type shown in FIG. 3.

### DETAILED DESCRIPTION

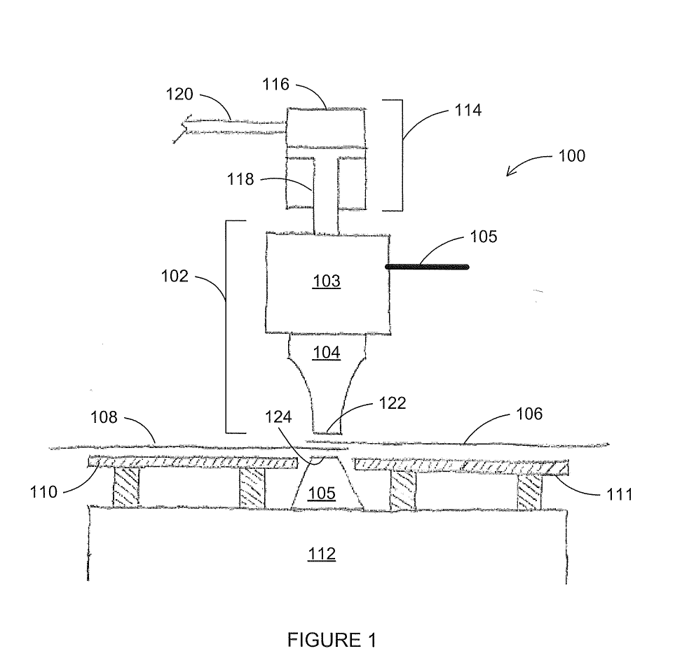

FIGS. 1 through 4, discussed below, and the various embodiments used to describe the principles of the present invention in this patent document are by way of illustration only and should not be construed in any way to limit the scope of the invention. Those skilled in the art will understand that the principles of the invention may be implemented in any suitably arranged gel string fabrication device.

FIG. 1 shows a front view of an apparatus 100 according to the present disclosure for fastening together pieces of filter material. An ultrasonic welding assembly 102 includes an ultrasonic transducer 103 and a horn 104. The transducer 103 converts electrical energy received via electrical conductor 105 into ultrasonic mechanical vibrations. The vibrations are transferred via the horn 104 to a surface 122. Any known technique for producing ultrasonic vibrations in the surface 122 may be used without departing from the scope of the present disclosure.

The apparatus 100 also includes an anvil 105 that is positioned opposite the ultrasonic welding assembly 102 and has a surface 124 positioned opposite the surface 122. The anvil 105 cooperates with the assembly 102 in the fastening process. Pieces of filter material 106 and 108 are overlapped and the overlapped portion positioned between the horn 104 and the anvil 105. The pieces 106 and 108 are supported on each side of the anvil 105 by supports 111 and 110, respectively. The anvil 105 and the supports 110 and 111 are attached to a common base 112. It will be understood that the supports 110 and 111 may be mounted to separate bases without departing from the scope of the present disclosure.

A distance between the ultrasonic welding assembly 102 and the anvil 105 is controlled by a positioning mechanism 114. In a preferred embodiment, the positioning mechanism 114 includes a piston 118, mechanically coupled to the ultrasonic welding assembly 102, operable to move within a cylinder 116, which is fixed in position relative to the anvil 105. The position of the piston 118 within the cylinder 116 may be controlled hydraulically via a conduit 120 coupled to the cylinder 116. As the piston 118 moves within the cylinder 116, the ultrasonic welding assembly 102 is moves closer to or farther from the anvil 105. Other mechanisms than a hydraulic mechanism may be used to position the ultrasonic welding assembly 102 relative to the anvil 105 without departing from the scope of the present disclosure.

In operation, once the pieces of filter material 106 and 108 are overlapped and positioned between the horn 104 and the anvil 105, the positioning mechanism 114 is operated to clamp the pieces 106 and 108 with a desired pressure. At the same time, electrical power is applied to the ultrasonic transducer 103 and the resulting ultrasonic vibrations of the surface 122 generates frictional heat in the piece 106 of filter material. One or both of the pieces 106 and 108 soften or melt, forming a bond between the pieces 106 and 108. It will be understood that other known techniques of heating the pieces 106 and/or 108 in a controlled manner may be used without departing from the scope of the present disclosure.

The pressure applied to the pieces 106 and 108 by the horn 104 and the anvil 105 is controlled, along with the duration of the ultrasonic vibrations, to securely fasten the pieces 106 and 108 together, without resulting in burn-through or significant weakening of the material. A desired pressure and duration may be determined based upon a thickness and type of material of each of the pieces 106 and 108.

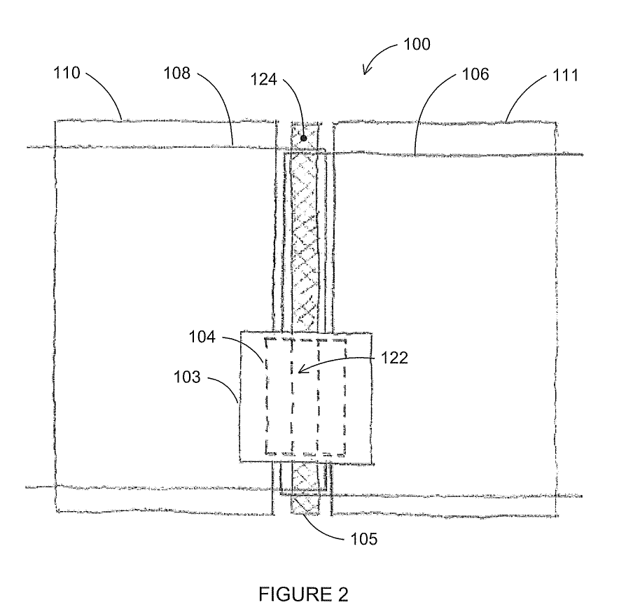

FIG. 2 depicts a top view of the apparatus 100. The anvil 105 is positioned between the supports 110 and 111. The pieces of filter material 106 and 108 are overlapped and laid on the anvil 105 and the supports 110 and 111. Above the pieces 106 and 108 is the ultrasonic transducer 103. The outlines of the horn 104 and the surface 122 are depicted by broken lines. Not shown in FIG. 2 are the base 112 and the positioning mechanism 114.

As shown in FIG. 2, the surface 124 of the anvil 105 may have a texture to improve the ultrasonic fastening process or the resulting bond between the pieces 106 and 108. Similarly, the surface 122 of the horn 104 may be textured.

As also shown in FIG. 2, the horn 104 may be smaller along its long dimension (in the vertical direction, as shown in FIG. 2) than is the anvil 105. When the pieces of filter material 106 and 108 are wider than the horn 104, the fastening process is performed in stages. A first area of the overlapped portion of the pieces 106 and 108 is clamped between the horn 104 and a corresponding portion of the anvil 105 and fastened. The horn is then lifted and repositioned along the anvil 105 to fasten a second area of the overlapped portion of the pieces 106 and 108. The first and second areas may overlap, in order to compensate for any variation in quality of the bond between the pieces 106 and 108 at the ends of the horn 104.

In other embodiments, the horn 104 and the anvil 105 may both be shorter than the width of the pieces 106 and 108 and may both be moved in order to fasten the pieces 106 and across their width. In other such embodiments, the pieces and 108 may be moved relative to the horn 104 and the anvil 105 in order to fasten the pieces 106 and 108 across their width.

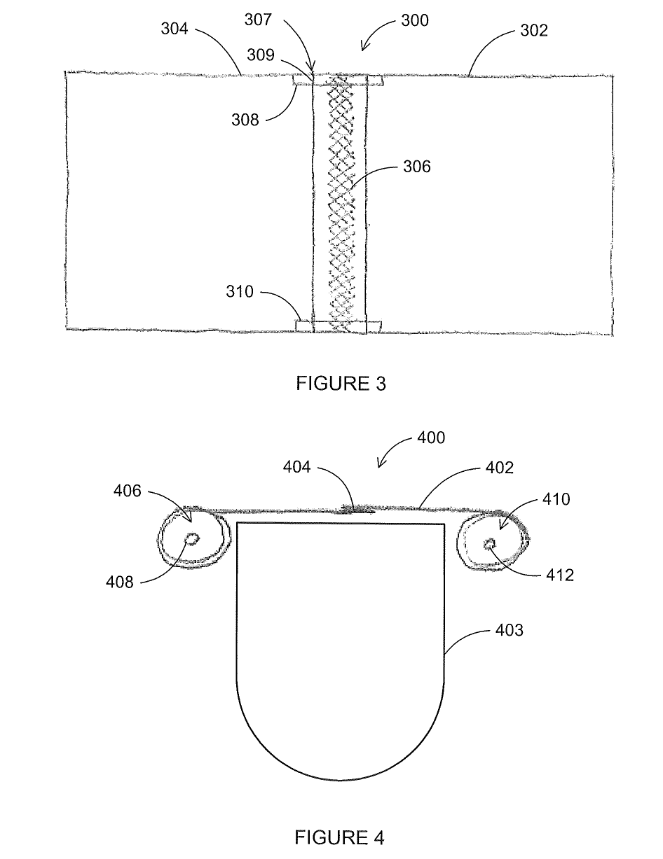

FIG. 3 shows a gel string 300 such as may be fabricated with the apparatus 100 of FIGS. 1 and 2. Pieces and 304 of filter material have been overlapped and fastened (or welded) along a seam 306. Where the overlap between the pieces 302 and 304 extends beyond the seam 306, one or more portions of pieces 302 and 304, such as corner 307 and/or edge 309, may be left un-welded. Once the gel string 300 is mounted in a gel scroller, the corner 307 or the edge 309 may catch on a part of the scroller when the gel string 300 is in motion, resulting in a weakening or tearing of the seam 306. To eliminate, or reduce the incidence of, such occurrences, adhesive tape 308 and 310, or other material, may be placed around the outer edges of the gel string 300 in the vicinity of the corner 307, to cover the corner 307 and/or a part of the edge 309.

While the seam 306 is shown in FIG. 3 positioned orthogonally across the pieces 302 and 304, it will be understood that the seam may be positioned at other angles than 90 degrees to the edges of the pieces 302 and 304 of filter material. Similarly, while the seam 306 and the adjacent edges of the pieces 302 and 304 are shown as straight lines, it will be understood that other shapes and configurations may be used, such as a zig-zag edges and/or seams.

FIG. 4 depicts a gel scroller 400 having mounted therein a gel string 402 of the type shown in FIG. 3. The gel string is wrapped at opposite ends around cylinders 406 and 410, respectively. The cylinders 406 and 410 are mounted to rotate around axes 408 and 412, respectively. A portion of the gel string 402 extending between the cylinders 406 and 410 extends across an aperture of a light fixture 403 and the light beam emitted by the light fixture 403. Motors and a controller (not shown in FIG. 4) may be coupled to the cylinders 406 and 410 and operated to position a desired portion of the gel string 402 across the light beam emitted by the light fixture 403.

As shown in FIG. 4, the gel string 402 may be positioned such that a seam 404 is across the aperture of the light fixture 403. The two filter pieces joined by the seam 404 may be color filters having differing colors and a subsequent optical element (not shown in FIG. 4) may blend or homogenize the two colors in the light beam into a single combined color. In such an embodiment, the location of the seam 404 would determine how much of each color filter was located across the light beam, thereby determining the color of the blended light beam.

The portion of the gel string 402 that is positioned across the light beam emitted by the light fixture 403 will absorb some of the light energy in the beam, resulting in heating of that portion of the gel string 402. Some other techniques for joining pieces of filter material to form a gel string result in a fastening that degrades when heated in this way. For example, the adhesive coating on adhesive tape used to join two pieces of filter material may fail when heated, resulting in such a gel string breaking. Even if the adhesive does not fail, the tape may discolor, resulting in an undesired color of the light beam. However, a gel string fabricated according to the method of the present disclosure places no material other than the filter material in the light beam and the welding process of the present disclosure may be performed so as not to weaken the filter material, with the result that any portion of the gel string 402 may be positioned in the light beam and suffer heat degradation at substantially the same rate as the individual pieces of filter material.

Although the present invention and its advantages have been described in the foregoing detailed description and illustrated in the accompanying drawings, it will be understood by those skilled in the art that the invention is not limited to the embodiment(s) disclosed but is capable of numerous rearrangements, substitutions and modifications without departing from the spirit and scope of the invention as defined by the appended claims.

What is claimed is:

1. A method comprising:
overlapping a first portion of a first piece of flexible filter material and a second portion of a second piece of flexible filter material, wherein the first piece of flexible filter material produces a first desired change in a first characteristic of a light beam and the second piece of flexible filter material produces a second desired change in one of the first and a second characteristic of the light beam;
clamping the first portion and the second portion between a first element and a second element; and
producing ultrasonic vibrations in the first element, whereby the first portion and the second portion are bonded.

2. The method of claim 1, wherein the first element comprises a first surface in contact with the first portion and the first surface comprises a texture.

3. The method of claim 1, wherein the steps of clamping and producing are applied to a first area of the first portion and the second portion and the method further comprises:
applying the steps of clamping and producing to a second area of the first portion and the second portion.

4. The method of claim 3, wherein the second area overlaps the first area.

5. The method of claim 1, further comprising covering a part of an edge of the first portion.

6. The method of claim 1 further comprising:
controlling a pressure with which the first portion and the second portion are clamped between the first element and the second element.

7. The method of claim 1 further comprising:
controlling an amount of time during which ultrasonic vibrations are produced in the first element.

8. A system, comprising:
a first filter material, wherein the first filter material creates a first alteration of at least one characteristic of a light beam passing through the first filter material;
a second filter material, wherein the second filter material creates a second alteration of at least one characteristic of the light beam passing through the first filter material;
a bond, wherein the bond comprises at least part of the first filter material and at least part of the second filter material, wherein the bond is created in situ through energy transferred to the first filter material, wherein the bond secures an overlap area of the first filter material and the second filter material.

9. The system of claim 8, wherein the energy is created through ultrasonic vibrations.

10. The system of claim 9, wherein the ultrasonic vibrations creates the bond in the form of a weld between the first filter material and the second filter material.

11. The system of claim 8, wherein the bond is created through heat transferred to the first filter element.

12. The system of claim 8, wherein a clamp is used to secure the first filter material and the second filter material during the creation of the bond.

13. The system of claim 8, wherein the bond is non-linear.

14. The system of claim 10, wherein the weld is textured to improve the seal.

15. A gel string prepared by a process comprising:
providing a first portion of a first piece of flexible filter material;
providing a second portion of a second piece of flexible filter material;
clamping the first portion and the second portion between a first element and a second element; and
producing ultrasonic vibrations in the first element, whereby the first portion and the second portion are bonded.

16. The method of claim 15, wherein the steps of clamping and producing are applied to a first area of the first portion and the second portion and the method further comprises:
applying the steps of clamping and producing to a second area of the first portion and the second portion.

17. The method of claim 16, wherein the second area overlaps the first area.

18. The method of claim 16, further comprising covering a part of an edge of the first portion.

19. The method of claim 16 further comprising:
controlling a pressure with which the first portion and the second portion are clamped between the first element and the second element.

20. The method of claim 16 further comprising:
controlling an amount of time during which ultrasonic vibrations are produced in the first element.
